(19) United States
(12) Patent Application Publication
(10) Pub. No.: US 2013/0319667 A1
(43) Pub. Date: Dec. 5, 2013

(54) DEGRADABLE LATEX AND METHOD

(71) Applicant: Yiyan Chen, Sugar Land, TX (US)

(72) Inventor: Yiyan Chen, Sugar Land, TX (US)

(73) Assignee: SCHLUMBERGER TECHNOLOGY CORPORATION, Sugar Land, TX (US)

(21) Appl. No.: 13/878,506

(22) PCT Filed: Oct. 18, 2011
(86) PCT No.: PCT/US2011/056674

§ 371 Date: Aug. 20, 2013

Related U.S. Application Data
(60) Provisional application No. 61/394,850, filed on Oct. 20, 2010.

(51) Int. Cl. C09K 8/62; E21B 43/26; E21B 43/267

(52) U.S. Cl. CPC C09K 8/62; E21B 43/267; E21B 43/26
USPC 166/280.1; 507/219; 507/231; 507/224; 507/225; 507/226; 507/230; 507/221; 507/211; 166/308.1

(57) ABSTRACT

Disclosed herein is a degradable latex comprising a stable dispersion of macromolecules in a liquid medium, wherein the macromolecules comprise a primary moiety comprising a plurality of functional groups, and a plurality of secondary moiety each chemically bonded through a labile linkage to the functional groups of the primary moiety, wherein at least a portion of residues of the secondary moiety are dispersible in the liquid medium. Methods of making and degrading the degradable latex, treating a formation and a treatment fluid are also disclosed.

### BACKGROUND

The statements in this section merely provide background information related to the present disclosure and may not constitute prior art.

In oilfield applications, lattices have been used for fluid loss control, gas migration control, film making and the like. In fluid loss control applications, latex and other forms of materials comprising a plurality of discrete particles are very useful in building an impermeable layer that prevents fluid from leaking into or out of the formation during particular stages of well preparation. However, the impermeable layer may prevent fluid production from the well.

To prevent total plugging of the production zone, the amount of latex or other similar material may be reduced to an amount sufficient to prevent the latex from forming a complete film on the formation surface. Other precautions may also be taken such as choosing the latex particle size to be bigger than the formation pore throat, use of a latex with a glass transition temperature (Tg), which is higher than the application temperature so that the latex particles will not be extruded into the formation pore, and the like.

### BRIEF DESCRIPTION OF THE SEVERAL VIEWS OF THE DRAWINGS

FIG. 1 schematically shows emulsion polymerization synthesis of degradable latex.

FIG. 2 schematically shows degradable latex generated through macromolecular reaction.

FIG. 3 schematically illustrates dendritic polymer degradation.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In this detailed description, each numerical value should be read once as modified by the term “about” (unless already expressly so modified), and then read again as not so modified unless otherwise indicated in context. Also, in this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.”

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. The fracturing methods otherwise use conventional techniques known in the art.

As used herein, the terms “bimodal” and “multimodal” with respect to particle size or other variable distribution have their standard statistical meanings. In statistics, a bimodal distribution is a continuous probability distribution with two different modes. A mixture is considered to be multimodal if it has two or more modes. These modes appear as distinct peaks (local maxima) in the probability density function. A bimodal distribution can arise as a mixture of two different unimodal distributions, i.e., distributions having only one mode. For example, a bimodally distributed particle size can be defined as PSD1 with probability .alpha. or PSD2 with probability (1−α), where PSD1 and PSD2 are different unimodal particle sizes and 0<α<1 is a mixture coefficient. A mixture of two unimodal distributions with differing means is not necessarily bimodal; however, a mixture of two normal distributions with similar variability is considered to be bimodal if their respective means differ by more than the sum of their respective standard deviations.

As used herein, the new numbering scheme for the Periodic Table Groups are used as in Chemical and Engineering News, 63(5), 27 (1985).

As used herein, the term “discrete particles” refers to a single macromolecule, or an agglomeration, combination or collection of a plurality of insoluble or immiscible macromolecules in a liquid medium, in contradistinction to a material which is soluble in the liquid medium. These macromolecules comprise polymer chains, oligomers or ligands chemically bonded to at least one primary moiety.

As used herein, the term “chemically bonded” includes any form of bonding that is characterized by the stable balance of attractive and repulsive forces between atoms sharing electrons, dipole-dipole interactions, and the like including covalent bonds, ionic bonds, dative bonds, back-bonds, or any combination thereof.

A material is said to be “dispersible” in a liquid medium if the material is at least partially soluble in the liquid medium, i.e., does not undergo Tyndall scattering, or which forms a colloid, an emulsion, or the like.

As used herein, the term “liquid medium” refers to a material which is liquid under the conditions of use. For example, a liquid medium may refer to water, and/or an organic solvent which is above the freezing point and below the boiling point of the material at a particular pressure. A liquid medium may also refer to a supercritical fluid.

The term “stable dispersion” refers to either a solution, or a dispersion of a solid material in a liquid wherein the material is a dispersed phase which is microscopically dispersed evenly throughout the liquid continuous phase and does not readily separate into two or more phases. Examples of a stable dispersion include colloidal dispersions, wherein the dispersed-phase macromolecules or particles have a diameter of greater than 1 nanometer. In some embodiment, the dispersed-phase macromolecules or particles have a diameter between about 1 and 20 nanometers and are normally invisible in an optical microscope. In some embodiment, the dispersed-phase macromolecules or particles have a diameter of up to 200 nanometers that can be visibly light scattering under microscope or with naked eyes but still possess excellent flowability in the fluid medium. In some further embodiment, the dispersed-phase macromolecules or particles have a diameter larger than 200 nanometers; as long as the dispersion exhibit acceptable flowability, such dispersed-phase macromolecules or particles are within the disclosure of the current application.

As used herein the term “labile linkage” includes a chemical bond which is likely to undergo change or to be unstable under certain conditions. Labile linkages include thermally labile bonds which break to produce a residue of the central moiety and a residue of at least one of the secondary moieties above a certain temperature. Labile linkages may further include acid labile bonds which break at a reduced pH relative to a pH at which the bonds are stable. In an embodiment acid labile bonds are broken at a pH below 7. Labile linkages may further include base labile bonds which break at a pH above a pH at which the bonds are stable. In an embodiment, base labile bonds are broken at a pH above 7. Labile linkages may further include oxidation labile bonds which break in the presence of an oxidizing agent at a particular concentration, and/or reduction labile bonds which break in the presence of a reducing agent at a particular concentration. Labile linkages may also break at conditions which comprise any combination of temperature, pH, concentration of oxidizing agent, concentration of reducing agent, solvent polarity, and/or the like. For example, a single labile linkage may be thermally labile, acid labile, and/or oxidation labile.

As used herein, the term “moiety” refers to a part of a larger molecule that includes at least one functional group as a substructure. Each functional group may be combined with any number of similar or different functional groups to produce still other functional groups. For example, a moiety comprising a carboxyl functional group may be combined with another moiety having a hydroxyl functional group to produce an ester functional group.

As used herein the term “secondary moiety” refers to a molecular group e.g., a radical, that binds to another chemical entity, which may include the primary moiety, to form a larger molecule; subject to the proviso that the residue of the moiety is dispersible in the liquid medium in which the material is present, which includes being soluble, in the liquid medium of interest.

As used herein the term “primary moiety” refers to a multifunctional molecule, a multifunctional polymer, a multigenerational dendrimer, or the like, but need not be a polymer itself. As used herein, primary moiety may include a material comprising polymeric chains or ligands attached to a functionalized inorganic support material, such as silica, titanium dioxide, alumina, and the like.

As used herein the term “residue of a moiety”, either a residue of a secondary moiety or a residue of a primary moiety, refers to the stable molecular form of the moiety unbound to the other molecule after breaking the labile linkage. For example, degradation of a degradable latex according to the instant disclosure, which comprises a secondary moiety bound to a primary moiety through an ester linkage, for instance, upon hydrolysis may result in the formation of a residue of the primary moiety, also referred to as a primary moiety residue, having a carboxylic acid or alcohol functional group and a residue of a secondary moiety, also referred to as a secondary moiety residue, having an alcohol or carboxylic acid functional group.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form the monomer. However, for ease of reference the phrase comprising the (respective) monomer or the like is used as shorthand.

The degradable latex disclosed herein is a latex resin or comprises a latex resin (also termed a latex polymer) comprising a plurality of discrete particles comprising macromolecules stabilized in a liquid medium. As used herein, the terms “degradable latex resin”, “degradable latex”, or “degradable latex polymer” refer to a dispersion of a degradable polymer comprising a plurality of discrete particles comprising macromolecules as described herein. In an embodiment, the degradable latex may be an aqueous emulsion of finely divided polymer particles produced from a blend of latex types and sizes. For purposes of this disclosure, the terms “latexes” and “latices” have the same meaning.

In an embodiment, the degradable latex comprises a stable dispersion of discrete particles comprising macromolecules in a liquid medium, wherein the macromolecules comprise a primary moiety comprising a plurality of functional groups and a plurality of ligands, referred to herein as secondary moieties, each of which are chemically bonded through a labile linkage to the functional groups of the primary moiety. In an embodiment, at least a portion of the residues of the secondary moiety are dispersible in the liquid medium.

For simplicity, the average particle size may be expressed herein as a particle diameter. However, it is to be understood that the particles may comprise one or more macromolecules and need not be spherical and need not be rigid. In an embodiment, the degradable latex comprises at least a portion of macromolecules or agglomerations of macromolecules, also referred to as discrete particles, having an average particle size greater than or equal to about 1 nanometer. In an embodiment the macromolecules or agglomerations of macromolecules have an average particle size from about 1 nanometer to about 10³ microns along an axis. In an embodiment, the degradable latex may comprise a bimodal or multimodal particle size distribution.

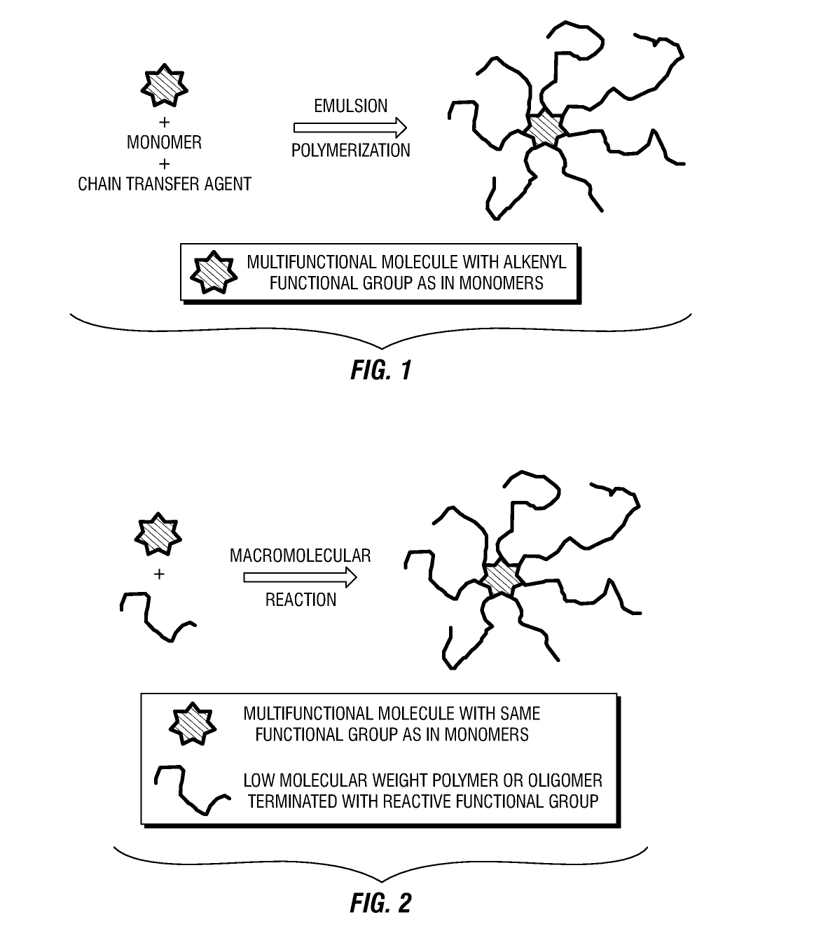

As shown in FIGS. 1, 2, and 3, in an embodiment, the degradable latex may be degraded by breaking the labile linkage between one or more of the primary moiety(s) and one or more of the secondary moiety to produce a degraded latex which comprises a primary moiety residue and one or more secondary moiety residues. Upon breaking of the labile linkage between the primary moiety and at least one secondary moiety, which is a chemical bond, a residue of the primary moiety is formed along with a residue of the one or more secondary moiety. In an embodiment, the labile linkage between the primary moiety and the secondary moiety is stable under a first set of conditions and is unstable and thus broken by subjecting the degradable latex to a second set of conditions. The first set of conditions and the second set of conditions, as well as the period of time it takes to produce a degraded latex depend on the type of primary moiety, the type of secondary moiety, the type of labile linkage between the two, and the environment in which the degradable latex is located. In an embodiment, the labile linkage between the primary moiety and the secondary moiety is broken by subjecting a degradable latex at a first condition for a period of time to a second condition which may include an elevated temperature relative to the first condition, and/or a reduced pH relative to the first condition, and/or an increased pH relative to the first condition, and/or the presence of an oxidizing agent at an increased concentration relative to the first condition, and/or the presence of a reducing agent at an increased concentration relative to the first condition, and/or a combination thereof, and/or the like.

In an embodiment, under a particular set of conditions, which may include temperature, the type of solvent, and the like, the labile linkage is pH sensitive such that at a first condition a chemical bond (e.g., a labile linkage) exists between the primary moiety and the secondary moiety. These first conditions may include a first pH range, and the second set of conditions may be brought about by raising or lowering the pH relative to the pH of the first condition.

In an embodiment, the labile linkage between the primary moiety and the secondary moiety is sensitive to the presence of an oxidizing agent or a reducing agent under a set of conditions which may include temperature and pH. In an embodiment, the primary moiety and at least one of the secondary moiety are chemically bonded to each other at a temperature and a pH in the absence of an amount of an oxidizing agent or a reducing agent, and the labile linkage is broken i.e., is debonded, at the same temperature and pH in the presence of an amount of the oxidizing agent or a reducing agent.

In an embodiment, the amount of oxidizing agent or reducing agent suitable to cleave the bond between the primary moiety and the secondary moiety is greater than or equal to about 0.01 wt % up to about 10 wt %, based on the total amount of the materials present. In an embodiment, the amount of oxidizing agent or reducing agent is greater than or equal to about 1 wt %.

In an embodiment, the oxidizing agent is selected from the group consisting of oxidizing acids, peroxides, hydroperoxides, peresters, peracids, and the like. Examples include sulfuric acid, oxygen, ozone, hydrogen peroxide, fluorine, nitric acid, persulfuric acid, chlorite, chlorate, perchlorate, and other analogous halogen compounds, hypochlorite and other hypohalite compounds, hexavalent chromium compounds such as chromic and dichromic acids and chromium trioxide, pyridinium chlorochromate, and chromate/dichromate compounds, permanganate compounds, sodium perborate, nitrous oxide, copper oxide, 2,2′-dipyridyldisulfide, combinations thereof, and the like.

In an embodiment, the reducing agent may include lithium aluminium hydride, atomic hydrogen, sodium amalgam, sodium borohydride, compounds containing the Sn2+ ion, such as tin(II) chloride and the like, sulfite compounds, sodium thiosulfite, hydrazine, zinc-mercury amalgam, diisobutylaluminum hydride, oxalic acid, formic acid, ascorbic acid, phosphites, hypophosphites, phosphorous acid, dithiothreitol, compounds containing the Fe2+ ion, such as iron(II) sulfate, amines, aldehyde-amine condensation products, anilines, toludines, combinations thereof, and the like.

In an embodiment, the functional groups of the primary moiety, the secondary moiety, or both, comprise atoms from Groups 13, 14, 15, 16, 17, of the periodic table, or a combination thereof.

In an embodiment, the functional groups present on the primary moiety, present on the secondary moiety, or both, comprise a hydroxyl, carboxyl, epoxy, nitro, nitroso, nitroamino, nitrosamino, nitrosimino, phosphinyl, phosphido, phosphito, phospho, phosphono, phosphoryl, selenyl, seleninyl, selenonyl, silanyl, siloxy, silyl, disilanyl, sulfamino, sulfinyl, sulfo, sulfonyl, sulfamyl, sulfeno, amino, amidino, amido, imido, azo, diazo, iso-cyano, cyano, cyanamido, diazoamino, hydrazino, hydrazo, mercapto, thiocarboxy, thenyl, thienyl, thiocyanato, thionyl, thiuram, tosyl, ethenyl (vinyl), or a combination thereof. These functional groups may be included in the labile linkage when the primary moiety is chemically bonded to the secondary moiety, and/or may be present in the residue of the primary moiety or the secondary moiety when the primary moiety is not chemically bonded to the secondary moiety.

In an embodiment, at least one of the secondary moiety is bonded to the primary moiety through an ester linkage, an amide linkage, an ether linkage, a thioether linkage, a disulfide linkage, or a combination thereof.

In an embodiment, the secondary moiety include an oligomer or a polymer having a molecular weight of greater than or equal to about 1,000 grams per mole (g/mol) and less than or equal to about 100,000 g/mol. In embodiments, the degradable latex comprises macromolecules having an average molecular weight of greater than or equal to about 5,000 g/mol, greater than or equal to about 10,000 g/mol, greater than or equal to about 500,000 g/mol, or greater than or equal to about 1,000,000 g/mol.

In an embodiment, the secondary moiety is a combination of monomers attached to the primary moiety during emulsion polymerization. As such, the secondary moiety is not attached to the primary moiety in tact, but is instead built up from the primary moiety.

In an embodiment, at least one of the secondary moiety comprises a polymer comprising styrene, butadiene, acrylonitrile, acrylic acid, acrylamide, methyl acrylate, ethyl acrylate, 2-chloroethyl vinyl ether, 2-ethylhexyl acrylate, hydroxyethyl methacrylate, butyl acrylate, butyl-methacrylate, trimethylolpropane triacrylate, vinyl acetate, vinyl alcohol, 2-acrylamido-2-methylpropane sulfonic acid, C₁-C₂₀ alpha olefins, ethylene oxide, propylene oxide, polysaccharide, chitin, chitosan, protein, aliphatic polyester, poly(lactide), poly-glycolide, poly-ε-carptolactone, poly-hydrooxybutyrate, poly-anhydride, aliphatic polycarbonate, poly-orthoester, poly-amino acid, polyphosphazene, or a combination thereof.

In an embodiment, the secondary moiety may be intra-molecularly crosslinked, which includes two secondary moiety attached to the same primary moiety which are also attached to each other, and a single secondary moiety bonded to itself at various points along its polymeric chain; the secondary moiety may be inter-molecularly crosslinked, including two secondary moieties, each attached to two separate primary moieties and to each other, and combinations thereof.

In an embodiment, the primary moiety may have no less than three functional groups that can be connected to the secondary moieties. The layout of these functional groups can be linearly (like a polymer chain, and the final polymer generated with this method is normally called comb polymer), star shape (final polymer is normally called a dendrimer), or even a functionalized macromolecule or particle (for example a functionalized silica).

In an embodiment, the primary moiety comprises an inorganic moiety comprising a plurality of terminal functional groups. Suitable inorganic moieties include metal oxides, hydroxides, carbonates, bicarbonates, sulfates, and/or phosphates from metals of Groups 1-14 of the periodic table of elements. Examples include silica, alumina, titanium dioxide, and the like.

In an embodiment, the primary moiety comprises a polyfunctional oligomer or polymer having a molecular weight of less than or equal to about 1000 g/mol, a multi-generational dendrimer comprising a plurality of functional groups, or a combination thereof. Suitable dendrimers include those described by Tomalia et al, Angew. Chem. Int. Ed. Engl., 29 (1990), 138, wherein dendrimers refer to three-dimensional highly-ordered oligomers or polymers. They are obtainable by reiterative reaction sequences starting from an initiator core having one or more reactive sites. To each reactive site is attached one functional group only of a polyfunctional reactant. The reactant is then caused to react through its remaining functional group or groups with additional molecules either the same as the original core if it is polyfunctional or a different, polyfunctional, molecule or molecules, and so on, in each case under reaction conditions such that unwanted side reactions, for example, crosslinking, are avoided. In this way, a dendritic body is built up around the primary core, each reiterative reaction sequence adding further reactants (or ‘units’) to the ends of the dendrites. Tomalia describes the manufacture of polyamidoamine (PAMAM) dendrimers; these may be made based on ammonia as a core, which is caused to react by Michael addition with methyl acrylate. The carboxyl group of the acrylate molecule is caused to react with one amino group only of ethylene diamine. The resulting triamine core cell is referred to by Tomalia as Generation 0; a further repetition provides a hexamine, referred to as Generation 1. Further repetitions produce higher generations which after Generation 4 result in concentric spheres of cells, the outermost sphere carrying external reactive groups. Other dendrimers described by Tomalia include polyethylenimine, hydrocarbon, polyether, polythioether, polyamide, polyamido-alcohol and polyarylamine dendrimers.

Suitable polyamide- and ester-based dendrimers are also described by Newkome et al, J. Am. Chem. Soc., 112 (1990) 8458. Use of a long-chain-alkylene dibromide as core provided a dendrimer (referred to by Newkome as an arboral) in the form of two spheres linked by an alkylene chain. U.S. Pat. No. 5,041,516 describes molecules similar to those of Tomalia, but made by a “convergent” approach, i.e., starting with the outer surface of the dendrimer, building up a wedge-shaped molecule, and finally reacting a plurality of the “wedges” with a core molecule. GB-A-1575507 describes star-shaped polymers and their use as viscosity improvers, these polymers being based on a cross-linked divinylbenzene core and isoprene branches; in EP-A-368395 such a hydrocarbon polymer is functionalized through a sulphonamide linkage to provide carboxyl terminal groups.

Branched, hyperbranched, and/or dendritic macromolecules (i.e., dendrimers) suitable for use herein may generally be described as three dimensional highly branched (i.e., hyperbranched) molecules having a tree-like structure. Suitable branched dendrimers may be highly symmetric, while similar macromolecules designated as branched, may, to a certain degree, hold an asymmetry, yet maintaining a highly branched tree-like structure. Dendrimers can be said to be monodispersed variations of branched macromolecules.

In an embodiment, the branched dendrimers suitable for use herein comprise an initiator or nucleus having one or more reactive sites and a number of surrounding branching layers and optionally a layer of chain terminating molecules. As is known in the art, the layers may be called generations, a designation hereinafter used. In an embodiment, branched dendritic or near dendritic macromolecules, also referred to herein as a branched dendritic core, may have three or more generations.

Degradation of the latex described herein results in the formation of a residue of the primary moiety and residues of the secondary moiety, which are at least partially soluble or dispersible in the liquid medium. In an embodiment, a dispersion comprising a residue of the primary moiety and the residues of the secondary moiety in the liquid medium, referred to herein as a degraded latex, may have a viscosity in the liquid medium of less than or equal to about 200 centi-Poise (cP), less than or equal to about 100 cP, or less than or equal to about 50 cP.

In an embodiment, a dispersion comprising a residue of the primary moiety and the residues of the secondary moiety at a total concentration of 4 wt % in water at 25° C. has a viscosity of less than or equal to about 200 cP, less than or equal to about 100 cP, or less than or equal to about 50 cP.

In an embodiment, the residue of the primary moiety may include portions of the secondary moieties such that the labile linkage may be present in the degradable latex at a point in the secondary moiety and thus, the degraded latex does not necessarily require the residue of the primary moiety to be free from all of the secondary moiety, but may comprise at least a portion of the secondary moiety or moieties as a residue.

In an embodiment, the liquid medium may comprise water and/or an organic solvent. The organic solvent may be selected from the group consisting of diesel oil, kerosene, paraffinic oil, crude oil, LPG, toluene, xylene, ether, ester, mineral oil, biodiesel, vegetable oil, animal oil, and mixtures thereof. Specific examples of suitable organic solvent include acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibuthylether, dimethyl-formamide (DMF), dimethyl sulfoxide (DMSO), dioxane, ethanol, ethyl acetate, ethylene glycol, glycerin, heptanes, Hexamethylphosphoramide (HMPA), Hexamethylphosphorous triamide (HMPT), hexane, methanol, methyl t-butyl ether (MTBE), methylene chloride, N-methyl-2-pyrrolidinone (NMP), nitromethane, pentane, Petroleum ether (ligroine), 1-propanol, 2-propanol, pyridine, tetrahydrofuran (THF), toluene, triethyl amine, o-xylene, m-xylene, p-xylene.

Further solvents include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as vaseline oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Terpenes include d-limonene, 1-limonene, dipentene (also known as 1-methyl-4-(1-methylethenyl)-cyclohexene), myrcene, alpha-pinene, linalool and mixtures thereof.

Further suitable organic liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono (alkyl or aryl)ethers of glycols, mono (alkyl or aryl)ethers of polyalkylene glycols and poly (alkyl and/or aryl)ethers of polyalkylene glycols, monoalkanoate esters of glycols, monoalkanoate esters of polyalkylene glycols, polyalkylene glycol esters like poly (alkyl and/or aryl)esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The organic liquid may also be selected from the group consisting of tetrahydrofuran, dioxane, dioxolane, methyltetrahydrofuran, dimethylsulfone, tetramethylene sulfone and thiophen.

The degradable latex material can be made by any number of methods. In an embodiment, the monomer or monomers of the secondary moiety may be combined with the primary moiety residue, in the presence of a chain transfer agent system (See, e.g. FIG. 1), a free-radical polymerization catalyst system, a surfactant system, an emulsion polymerization catalyst system, an acid catalyst, a base catalyst, a polymerization catalyst system, or a combination thereof, to produce the secondary moiety through emulsion polymerization or the like and in doing so, produce the degradable latex. High concentrations of a chain transfer agent may be needed to keep the individual chain length of the secondary moiety attached to the primary moiety at an appropriate length.

In another embodiment, e.g. FIG. 2, residues of the secondary moiety or moieties are produced and then contacted with the primary moiety residue under conditions sufficient to react the components to produce the degradable latex. For example, the secondary moiety residue may comprise an alcohol functionality and the primary moiety may comprise a carboxylic acid functionality, the two components may be combined under either acidic or basic conditions and reacted to produce an ester linkage between the secondary moiety and the primary moiety. These two compounds may be reacted prior to being placed downhole, or may be reacted downhole to produce the degradable latex in-situ.

In an embodiment, a method to produce a degradable latex comprises contacting a residue of a primary moiety comprising a plurality of functional groups with a plurality of residues of secondary moiety under reaction conditions to produce macromolecules dispersible in a liquid medium, wherein the macromolecules comprise at least a portion of the plurality of secondary moiety each chemically bonded through a liable linkage to the functional groups of the primary moiety, wherein at least a portion of the residues of the secondary moiety are dispersible in the liquid medium.

In an embodiment, the residue of the primary moiety is contacted with the plurality of residues of secondary moiety in the presence of a free-radical polymerization catalyst system, a surfactant system, an emulsion polymerization catalyst system, an acid catalyst, a base catalyst, a polymerization catalyst system, or a combination thereof.

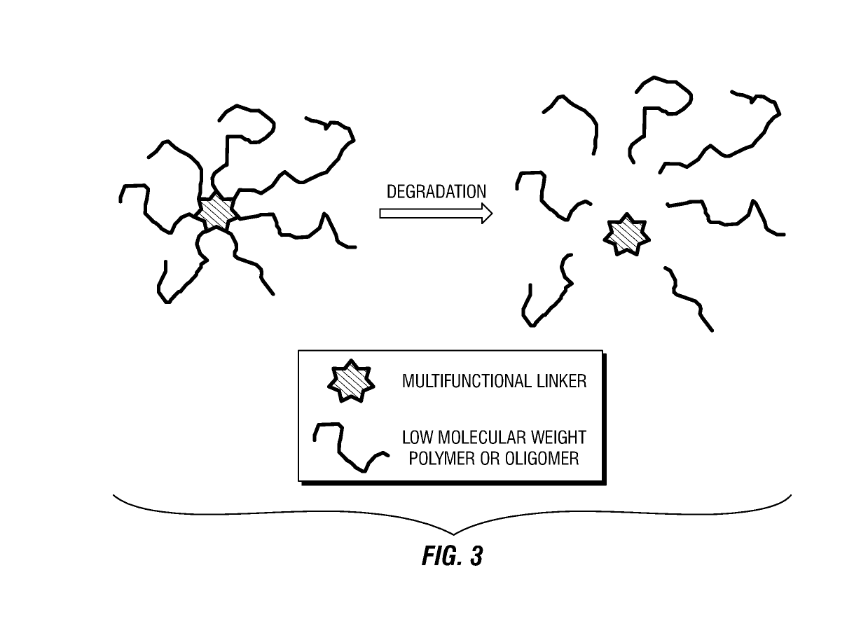

According to embodiments disclosed herewith, the high molecular weight degradable latex is able to be degraded under conditions achievable down hole, e.g. FIG. 3. In an embodiment, the latex is degraded into multiple pieces; each piece being sufficiently small such that cleanup is easily achieved.

In an embodiment, a method of degrading a degradable latex as described herein comprises subjecting the degradable latex to a temperature and for a period of time sufficient to break at least a portion of the labile linkages between the primary moiety and the secondary moiety to produce a degraded latex comprising a residue of the primary moiety and a plurality of residues of the secondary moiety. In an embodiment, the method of degrading the degradable latex may further comprise contacting the degradable latex with an acid, a base, an oxidizing agent, a reducing agent, or a combination thereof to produce the degraded latex.

In an embodiment, a method of treating a formation penetrated by a wellbore comprises preparing a well treatment fluid comprising the degradable latex described herein, which comprises macromolecules comprising a plurality of secondary moiety each chemically bonded to a primary moiety through a labile linkage, followed by injecting the well treatment fluid into the wellbore, wherein at least a portion of the degradable latex penetrates the formation; and subjecting the degradable latex to a temperature and for a period of time sufficient to break at least a portion of the labile linkages between the primary moiety and the secondary moiety to produce a degraded latex comprising a residue of the primary moiety and a plurality of residues of the secondary moiety.

In an embodiment, a method of treating a formation penetrated by a wellbore may further comprise contacting the degradable latex penetrating the formation with an acid, a base, an oxidizing agent, a reducing agent, or a combination thereof, to produce the degraded latex. In an embodiment, the viscosity of the degradable latex dispersed in a liquid medium is greater than the viscosity of the degraded latex dispersed in the same liquid medium at the same temperature and concentration. In an embodiment, the degradable latex comprises a mixture of degradable latexes having different particle sizes. In an embodiment, the use of the degradable latex in treating a formation penetrated by a wellbore is subject to the proviso that no conventional fluid loss additive is incorporated into the well treatment fluid.

According to an embodiment, a composition comprising degradable latex is used with a carrier fluid as a fracturing fluid. Accordingly, a method of fracturing a formation penetrated by a wellbore may comprise preparing a well treatment fluid comprising a degradable latex comprising macromolecules comprising a plurality of secondary moiety each chemically bonded to a primary moiety through a labile linkage, injecting the well treatment fluid into the wellbore at a pressure equal to or greater than the formation's fracture initiation pressure such that at least a portion of the degradable latex penetrates the formation, and thereafter optionally injecting into the wellbore a proppant laden fluid at a pressure equal to or greater than the formation's fracture initiation pressure. The method may further comprise subjecting the degradable latex present in the formation to a temperature and for a period of time sufficient to break at least a portion of the labile linkages between the primary moiety and the secondary moiety to produce a degraded latex comprising a residue of the primary moiety and a plurality of secondary moiety residues, and/or contacting the degradable latex penetrating the formation with an acid, a base, an oxidizing agent, a reducing agent, or a combination thereof, to produce the degraded latex.

In an embodiment, the well treatment fluid, also referred to as the carrier fluid, may have optionally a viscosifying agent or viscosifier. The carrier fluid may include any base fracturing fluid understood in the art. Some non-limiting examples of carrier fluids include hydratable gels (e.g. guars, poly-saccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N2 or CO2 based foam), and an oil-based fluid including a gelled, foamed, or otherwise viscosified oil. Additionally, the carrier fluid may be a brine, and/or may include a brine.

The viscosifying agent may be any crosslinked polymers. The polymer viscosifier can be a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes used to increase the effective molecular weight of the polymer and make them suited for use in high-temperature wells.

Other suitable classes of polymers effective as viscosifying agent include polyvinyl polymers, polymethacrylamides, cellulose ethers, lignosulfonates, and ammonium, alkali metal, and alkaline earth salts thereof. More specific examples of other water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent particulate-suspension ability even though they are more expensive than guar derivatives and therefore have been used less frequently, unless they can be used at lower concentrations.

In other embodiments, the viscosifying agent is made from a crosslinkable, hydratable polymer and a delayed crosslinking agent, wherein the crosslinking agent comprises a complex comprising a metal and a first ligand selected from the group consisting of amino acids, phosphono acids, and salts or derivatives thereof. Also the crosslinked polymer can be made from a polymer comprising pendant ionic moieties, a surfactant comprising oppositely charged moieties, a clay stabilizer, a borate source, and a metal crosslinker. Said embodiments are described in U.S. Patent Publications US2008-0280790 and US2008-0280788 respectively, each of which are incorporated herein by reference.

The viscosifying agent may be a viscoelastic surfactant (VES). The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid substantially exceeds a certain concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactants of the family of betaine is used.

Applicable cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R¹N⁺(R²)(R³)(R⁴)X⁻

in which R¹ has from about 14 to about 26 carbon atoms and may be branched or straight chained, aromatic, saturated or unsaturated, and may contain a carbonyl, an amide, a retroamide, an imide, a urea, or an amine; R², R³, and R⁴ are each independently hydrogen or a C₁ to about C₆ aliphatic group which may be the same or different, branched or straight chained, saturated or unsaturated and one or more than one of which may be substituted with a group that renders the R², R³, and R⁴ group more hydrophilic; the R², R³, and R⁴ groups may be incorporated into a heterocyclic 5- or 6-member ring structure which includes the nitrogen atom; the R², R³, and R⁴ groups may be the same or different; R¹, R², R³, and/or R⁴ may contain one or more ethylene oxide and/or propylene oxide units; and X— is an anion. Mixtures of such compounds are also suitable. As a further example, R¹ is from about 18 to about 22 carbon atoms and may contain a carbonyl, an amide, or an amine, and R², R³, and R⁴ are the same as one another and contain from 1 to about 3 carbon atoms.

Amphoteric viscoelastic surfactants are also suitable. Applicable amphoteric viscoelastic surfactant systems include those described in U.S. Pat. No. 6,703,352, for example amine oxides. Other applicable viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R¹CON(R²)CH₂X

wherein R¹ is a hydrophobic chain having about 12 to about 24 carbon atoms, R² is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

In certain embodiments, the carrier fluid includes an acid. The fracture may be a traditional hydraulic bi-wing fracture, but in certain embodiments may be an etched fracture and/or wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation, compatibility with fluids in the formation, and compatibility with other components of the fracturing slurry and with spacer fluids or other fluids that may be present in the wellbore. The selection of an acid for the carrier fluid is understood in the art based upon the characteristics of particular embodiments and the disclosures herein.

The composition may include a particulate blend made of proppant. Proppant selection involves many compromises imposed by economical and practical considerations. Criteria for selecting the proppant type, size, size distribution in multimodal proppant selection, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In some embodiments, irregular shaped particles may be used such as unconventional proppant. In general the proppant used will have an average particle size of from about 0.15 mm to about 4.76 mm (about 100 to about 4 U.S. mesh), sometimes from about 0.15 mm to about 3.36 mm (about 100 to about 6 U.S. mesh), sometimes from about 0.15 mm to about 4.76 mm (about 100 to about 4 U.S. mesh), sometimes from 0.25 to 0.42 mm (40/60 mesh), 0.42 to 0.84 mm (20/40 mesh), 0.84 to 1.19 mm (16/20), 0.84 to 1.68 mm (12/20 mesh) and 0.84 to 2.38 mm (8/20 mesh) sized materials. Normally the proppant will be present in the slurry in a concentration from about 0.12 to about 0.96 kg/L, or from about 0.12 to about 0.72 kg/L, or from about 0.12 to about 0.54 kg/L. Also, they are slurry where the proppant is at a concentration up to 16 PPA (1.92 kg/L). If the slurry is foamed the proppant is at a concentration up to 20 PPA (2.4 kg/L). The storable composition is not a cement slurry composition.

The composition may comprise particulate materials with defined particle size distribution. Examples of high solid content treatment fluid (HSCF) in which the degradable latex may be employed are disclosed in U.S. Pat. No. 7,789,146; U.S. Pat. No. 7,784,541; US 2010/0155371; US 2010/0155372; US 2010/0243250; and US 2010/0300688; all of which are hereby incorporated herein by reference in their entireties.

The composition may further comprise a degradable material. In certain embodiments, the degradable material includes at least one of a lactide, a glycolide, an aliphatic polyester, a poly (lactide), a poly (glycolide), a poly (ε-caprolactone), a poly (orthoester), a poly (hydroxybutyrate), an aliphatic polycarbonate, a poly (phosphazene), and a poly (anhydride). In certain embodiments, the degradable material includes at least one of a poly (saccharide), dextran, cellulose, chitin, chitosan, a protein, a poly (amino acid), a poly (ethylene oxide), and a copolymer including poly (lactic acid) and poly (glycolic acid). In certain embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

In some embodiments, the composition may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the storable composition using a gas, such as air, nitrogen, or carbon dioxide.

The composition may be used for carrying out a variety of subterranean treatments, including, but not limited to, drilling operations, fracturing treatments, and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is to create a short, wide, highly conductive fracture, in order to bypass near-wellbore damage done in drilling and/or completion, to ensure good fluid communication between the reservoir and the wellbore and also to increase the surface area available for fluids to flow into the wellbore.

Accordingly, the present disclosure provides the following embodiments:

A. A degradable latex comprising:
a dispersion of macromolecules in a liquid medium,
the macromolecules comprising one or more primary moiety each comprising a plurality of functional groups, and
a plurality of secondary moiety each of which are chemically bonded through a labile linkage to the functional groups of the one or more primary moiety under a first condition, and are unbonded to the one or more primary moiety under a second condition, and
at least a portion of residues of the secondary moiety are dispersible in the liquid medium.

B. The degradable latex of embodiment A, wherein at least a portion of the macromolecules have a particle size from about 1 nanometer to about 1000 microns.

C. The degradable latex of embodiment A or B, wherein a temperature of the first condition is less than the temperature of the second condition, wherein a pH of the first condition is less than the pH of the second condition, wherein the pH of the first condition is greater than the pH of the second condition, wherein a concentration of an oxidizing agent of the second condition is greater than the concentration of the oxidizing agent of the first condition, wherein a concentration of a reducing agent of the second condition is greater than the concentration of the reducing agent of the first condition, or a combination thereof.

D. The degradable latex of embodiment A, B, or C, wherein the labile linkages comprise an ester linkage, an amide linkage, an ether linkage, a thioether linkage, or a combination thereof.

E. The degradable latex of embodiment A, B, C, or D, wherein the secondary moiety comprise an oligomer or a polymer having a weight average molecular weight of greater than or equal to about 1,000 g/mol and less than or equal to about 100,000 g/mol.

F. The degradable latex of embodiment A, B, C, D or, E, wherein the macromolecules have a weight average molecular weight of greater than or equal to about 10,000 g/mol.

G. The degradable latex of embodiment A, B, C, D, E, or F, wherein the secondary moiety comprise a polymer or oligomer comprising styrene, butadiene, acrylonitrile, acrylic acid, acrylamide, methyl acrylate, ethyl acrylate, 2-chloroethyl vinyl ether, 2-ethylhexyl acrylate, hydroxyethyl methacrylate, butyl acrylate, butyl-methacrylate, trimethylolpropane triacrylate, vinyl acetate, vinyl alcohol, 2-acrylamido-2-methylpropane sulfonic acid, C₁-C₂₀ alpha olefins, ethylene oxide, propylene oxide, polysaccharide, chitin, chitosan, protein, aliphatic polyester, poly(lactide), poly-glycolide, poly-ε-carptolactone, poly-hydrooxybutyrate, poly-anhydride, aliphatic polycarbonate, poly-orthoester, poly-amino acid, polyphosphazene, or a combination thereof.

H. The degradable latex of embodiment A, B, C, D, E, F, or G, wherein at least two of the secondary moiety are cross-linked.

I. The degradable latex of embodiment A, B, C, D, E, F, G, or H, wherein the primary moiety comprises an inorganic moiety comprising a plurality of terminal functional groups.

J. The degradable latex of embodiment A, B, C, D, E, F, G, H, or I, wherein the primary moiety comprises a polyfunctional oligomer or polymer having a molecular weight of less than or equal to about 1000 g/mol, a multi-generational dendrimer comprising a plurality of functional groups, or a combination thereof.

K. The degradable latex of embodiment A, B, C, D, E, F, G, H, I, or J, wherein a dispersion comprising a residue of the primary moiety and the residues of the secondary moiety in the liquid medium has a viscosity in the liquid medium of less than or equal to about 200 cP.

L. The degradable latex of embodiment A, B, C, D, E, F, G, H, I, J, or K, wherein a dispersion comprising a residue of the primary moiety and the residues of the secondary moiety at a total concentration of 4 wt % in water at 25° C. has a viscosity of less than or equal to about 200 cP.

M. The degradable latex of embodiment A, B, C, D, E, F, G, H, I, J, K or L, wherein the functional groups comprise hydroxyl, carboxyl, epoxy, nitro, nitroso, nitroamino, nitrosamino, nitrosimino, phosphinyl, phosphido, phosphito, phospho, phosphono, phosphoryl, selenyl, seleninyl, selenonyl, silanyl, siloxy, silyl, disilanyl, sulfamino, sulfinyl, sulfo, sulfonyl, sulfamyl, sulfeno, amino, amidino, amido, imido, azo, diazo, iso-cyano, cyano, cyanamido, diazoamino, hydrazino, hydrazo, mercapto, thiocarboxy, thenyl, thienyl, thiocyanato, thionyl, thiuram, tosyl, ethenyl (vinyl), or a combination thereof.

N. A method to produce a degradable latex comprising:

contacting a plurality of precursors of a primary moiety each comprising a plurality of functional groups with a plurality of precursors of secondary moiety under reaction conditions to produce a plurality of macromolecules dispersible in a liquid medium, wherein the macromolecules comprise at least a portion of the plurality of secondary moiety each of which are chemically bonded through a liable linkage to the functional groups of the primary moiety under a first condition, and are unbonded to the one or more primary moiety under a second condition, wherein at least a portion of the residues of the secondary moiety are dispersible in the liquid medium.

O. The method of embodiment N, wherein the precursor of the primary moiety is contacted with the precursors of secondary moiety in the presence of a free-radical polymerization catalyst system, a surfactant system, an emulsion polymerization catalyst system, an acid catalyst, a base catalyst, a polymerization catalyst system, or a combination thereof.

P. A method of degrading a degradable latex comprising a plurality of macromolecules comprising a plurality of secondary moiety each chemically bonded to a primary moiety through a labile linkage, the method of degrading comprising:

subjecting the degradable latex to conditions effective to break at least a portion of the labile linkages between the primary moiety and the secondary moiety to produce a degraded latex comprising a residue of the primary moiety and a plurality of residues of the secondary moiety.

Q. The method of degrading a degradable latex of embodiment P, comprising contacting the degradable latex with an acid, a base, an oxidizing agent, a reducing agent, or a combination thereof to degrade the degradable latex.

R. A method of treating a formation, comprising:
a. preparing a treatment fluid comprising a degradable latex comprising a plurality of macromolecules, the macromolecules comprising one or more primary moiety each comprising a plurality of functional groups, and a plurality of secondary moiety, each of which are chemically bonded through a labile linkage to the functional groups of the one or more primary moiety under a first condition, and are unbonded to the one or more primary moiety under a second condition, and at least a portion of residues of the secondary moiety are dispersible in the liquid medium;
b. contacting the formation with the treatment fluid; and
c. subjecting the degradable latex to the second condition to break at least a portion of the labile linkages between the primary moiety and the secondary moiety to produce residues of the primary and secondary moiety.

S. The method of embodiment R, wherein the second condition comprises contacting the degradable latex with an acid, a base, an oxidizing agent, a reducing agent, or a combination thereof, to degrade the degradable latex.

T. The method of embodiment R or S, wherein the degradable latex comprises a mixture of degradable latexes having different particle sizes.

U. The method of embodiment R, S, or T, wherein the degradable latex inhibits fluid loss into the formation.

V. A method of fracturing a formation, the method comprising:
a. preparing a treatment fluid comprising a degradable latex comprising a plurality of macromolecules, the macromolecules comprising one or more primary moiety each comprising a plurality of functional groups, and a plurality of secondary moiety, each of which are chemically bonded through a labile linkage to the functional groups of the one or more primary moiety under a first condition, and are unbonded to the one or more primary moiety under a second condition, and at least a portion of residues of the secondary moiety are dispersible in the liquid medium;
b. injecting the treatment fluid into contact with the formation at a pressure equal to or greater than a fracture initiation pressure of the formation such that at least a portion of the treatment fluid penetrates the formation; and
c. thereafter optionally injecting into the formation a proppant laden fluid at a pressure equal to or greater than the fracture initiation pressure.

W. The method of embodiment U, further comprising subjecting the degradable latex in the formation to the second condition to produce residues of the primary and secondary moiety.

X. The method of embodiment U or W, wherein the second condition comprises contacting the degradable latex in the formation with an acid, a base, an oxidizing agent, a reducing agent, or a combination thereof, to degrade the degradable latex.

Y. The method of embodiment U, W, or X, wherein the viscosity of the fluid comprising the degraded latex is less than or equal to about 200 cP.

Z. A treatment fluid, comprising:

a degradable latex comprising a stable dispersion of a plurality of macromolecules in a liquid medium;

the macromolecules comprising one or more primary moiety each comprising a plurality of functional groups, and

a plurality of secondary moiety, each of which are chemically bonded through a labile linkage to the functional groups of the one or more primary moiety under a first condition, and are unbonded to the one or more primary moiety under a second condition, and

at least a portion of residues of the secondary moiety are dispersible in the liquid medium.

The foregoing disclosure and description are illustrative and explanatory thereof and it can be readily appreciated by those skilled in the art that various changes in the size, shape and materials, as well as in the details of the illustrated construction or combinations of the elements described herein can be made without departing from the spirit of the present application.

While the current application has been illustrated and described in detail in the drawings and foregoing description, the same is to be considered as illustrative and not restrictive in character, it being understood that only some embodiments have been shown and described and that all changes and modifications that come within the spirit of the current application are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the current application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Although only a few example embodiments have been described in detail above, those skilled in the art will readily appreciate that many modifications are possible in the example embodiments without materially departing from this application. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

I claim:

1. A degradable latex comprising:
a dispersion of macromolecules in a liquid medium,
the macromolecules comprising one or more primary moiety each comprising a plurality of functional groups, and
a plurality of secondary moiety each of which are chemically bonded through a labile linkage to the functional groups of the one or more primary moiety under a first condition, and are unbonded to the one or more primary moiety under a second condition, and
at least a portion of residues of the secondary moiety are dispersible in the liquid medium.

2. The degradable latex of claim 1, wherein at least a portion of the macromolecules have a particle size from about 1 nanometer to about 1000 microns.

3. The degradable latex of claim 1, wherein the temperature of the first condition is less than the temperature of the second condition, wherein the pH of the first condition is less than the pH of the second condition, wherein the pH of the first condition is greater than the pH of the second condition, wherein the concentration of an oxidizing agent of the second condition is greater than the concentration of the oxidizing agent of the first condition, wherein the concentration of a reducing agent of the second condition is greater than the concentration of the reducing agent of the first condition, or a combination thereof.

4. The degradable latex of claim 1, wherein the labile linkages comprise an ester linkage, an amide linkage, an ether linkage, a thioether linkage, or a combination thereof.

5. The degradable latex of claim 1, wherein the secondary moiety comprise an oligomer or a polymer having a weight average molecular weight of greater than or equal to about 1,000 g/mol and less than or equal to about 100,000 g/mol.

6. The degradable latex of claim 1, wherein the macromolecules have a weight average molecular weight of greater than or equal to about 10,000 g/mol.

7. The degradable latex of claim 1, wherein the secondary moiety comprise a polymer or oligomer comprising styrene, butadiene, acrylonitrile, acrylic acid, acrylamide, methyl acrylate, ethyl acrylate, 2-chloroethyl vinyl ether, 2-ethylhexyl acrylate, hydroxyethyl methacrylate, butyl acrylate, butyl-methacrylate, trimethylolpropane triacrylate, vinyl acetate, vinyl alcohol, 2-acrylamido-2-methylpropane sulfonic acid, C₁-C₂₀ alpha olefins, ethylene oxide, propylene oxide, polysaccharide, chitin, chitosan, protein, aliphatic polyester, poly(lactide), poly-glycolide, poly-ε-carptolactone, poly-hydrooxybutyrate, poly-anhydride, aliphatic polycarbonate, poly-orthoester, poly-amino acid, polyphosphazene, or a combination thereof.

8. The degradable latex of claim 1, wherein at least two of the secondary moiety are cross-linked.

9. The degradable latex of claim 1, wherein the primary moiety comprises an inorganic moiety comprising a plurality of terminal functional groups.

10. The degradable latex of claim 1, wherein the primary moiety comprises a polyfunctional oligomer or polymer having a molecular weight of less than or equal to about 1000 g/mol, a multi-generational dendrimer comprising a plurality of functional groups, or a combination thereof.

11. The degradable latex of claim 1, wherein a dispersion comprising a residue of the primary moiety and the residues of the secondary moiety in the liquid medium has a viscosity in the liquid medium of less than or equal to about 200 cP.

12. The degradable latex of claim 1, wherein a dispersion comprising a residue of the primary moiety and the residues of the secondary moiety at a total concentration of 4 wt % in water at 25° C. has a viscosity of less than or equal to about 200 cP.

13. The degradable latex of claim 1, wherein the functional groups comprise hydroxyl, carboxyl, epoxy, nitro, nitroso, nitroamino, nitrosamino, nitrosimino, phosphinyl, phosphido, phosphito, phospho, phosphono, phosphoryl, selenyl, seleninyl, selenonyl, silanyl, siloxy, silyl, disilanyl, sulfamino, sulfinyl, sulfo, sulfonyl, sulfamyl, sulfeno, amino, amidino, amido, imido, azo, diazo, iso-cyano, cyano, cyanamido, diazoamino, hydrazino, hydrazo, mercapto, thiocarboxy, thenyl, thienyl, thiocyanato, thionyl, thiuram, tosyl, ethenyl (vinyl), or a combination thereof.

14. A method to produce a degradable latex comprising:
contacting a plurality of precursors of a primary moiety each comprising a plurality of functional groups with a plurality of precursors of secondary moiety under reaction conditions to produce a plurality of macromolecules dispersible in a liquid medium, wherein the macromolecules comprise at least a portion of the plurality of secondary moiety each of which are chemically bonded through a liable linkage to the functional groups of the primary moiety under a first condition, and are unbonded to the one or more primary moiety under a second condition, wherein at least a portion of the residues of the secondary moiety are dispersible in the liquid medium.

15. The method of claim 14, wherein the precursor of the primary moiety is contacted with the precursors of secondary moiety in the presence of a free-radical polymerization catalyst system, a surfactant system, an emulsion polymerization catalyst system, an acid catalyst, a base catalyst, a polymerization catalyst system, or a combination thereof.

16. A method of degrading a degradable latex comprising a plurality of macromolecules comprising a plurality of secondary moiety each chemically bonded to a primary moiety through a labile linkage, the method of degrading comprising:
subjecting the degradable latex to conditions effective to break at least a portion of the labile linkages between the primary moiety and the secondary moiety to produce a degraded latex comprising a residue of the primary moiety and a plurality of residues of the secondary moiety.

17. The method of degrading a degradable latex of claim 16, comprising contacting the degradable latex with an acid, a base, an oxidizing agent, a reducing agent, or a combination thereof to degrade the degradable latex.

18. A method of treating a formation, comprising:
a. preparing a treatment fluid comprising a degradable latex comprising a plurality of macromolecules, the macromolecules comprising one or more primary moiety each comprising a plurality of functional groups, and
a plurality of secondary moiety, each of which are chemically bonded through a labile linkage to the functional groups of the one or more primary moiety under a first condition, and are unbonded to the one or more primary moiety under a second condition, and
at least a portion of residues of the secondary moiety are dispersible in the liquid medium;
b. contacting the formation with the treatment fluid; and
c. subjecting the degradable latex to the second condition to break at least a portion of the labile linkages between the primary moiety and the secondary moiety to produce residues of the primary and secondary moiety.

19. The method of claim 18, wherein the second condition comprises contacting the degradable latex with an acid, a base, an oxidizing agent, a reducing agent, or a combination thereof, to degrade the degradable latex.

20. The method of claim 18, wherein the degradable latex comprises a mixture of degradable latexes having different particle sizes.

21. The method of claim 18, wherein the degradable latex inhibits fluid loss into the formation.

22. A method of fracturing a formation, the method comprising:
a. preparing a treatment fluid comprising a degradable latex comprising a plurality of macromolecules, the macromolecules comprising one or more primary moiety each comprising a plurality of functional groups, and
a plurality of secondary moiety, each of which are chemically bonded through a labile linkage to the functional groups of the one or more primary moiety under a first condition, and are unbonded to the one or more primary moiety under a second condition, and
at least a portion of residues of the secondary moiety are dispersible in the liquid medium;
b. injecting the treatment fluid into contact with the formation at a pressure equal to or greater than a fracture initiation pressure of the formation such that at least a portion of the treatment fluid penetrates the formation; and
c. thereafter optionally injecting into the formation a proppant laden fluid at a pressure equal to or greater than the fracture initiation pressure.

23. The method of claim 22 further comprising subjecting the degradable latex in the formation to the second condition to produce residues of the primary and secondary moiety.

24. The method of claim 22, wherein the second condition comprises contacting the degradable latex in the formation with an acid, a base, an oxidizing agent, a reducing agent, or a combination thereof, to degrade the degradable latex.

25. The method of claim 22, wherein the viscosity of the fluid comprising the degraded latex is less than or equal to about 200 cP.

26. A treatment fluid, comprising:
a degradable latex comprising a stable dispersion of a plurality of macromolecules in a liquid medium;
the macromolecules comprising one or more primary moiety each comprising a plurality of functional groups, and
a plurality of secondary moiety, each of which are chemically bonded through a labile linkage to the functional groups of the one or more primary moiety under a first condition, and are unbonded to the one or more primary moiety under a second condition, and
at least a portion of residues of the secondary moiety are dispersible in the liquid medium.
